(19) United States
(12) Patent Application Publication
(10) Pub. No.: US 2006/0071495 A1
(43) Pub. Date: Apr. 6, 2006

(54) Telescoping luggage cover

(76) Inventors: Thomas Steigerwald, Rochester Hills, MI (US); Russell Ketteringham, Lake Orion, MI (US); Ed Steinmetz, Lapeer, MI (US)

Correspondence Address: HARNESS, DICKEY & PIERCE, P.L.C., P.O. BOX 828, BLOOMFIELD HILLS, MI, 48303, US

(21) Appl. No.: 10/957,188

(22) Filed: Oct. 1, 2004

(51) Int. Cl. B60R 5/04

(52) U.S. Cl. 296/24.4

(57) ABSTRACT

First and second generally C-shaped housing members move in telescoping relationship between an expanded state and a collapsed state. First and second roll-out cover mechanisms are associated with the corresponding first and second housing members and positioned to avoid interfering with each other upon collapsing and expanding the housing. A first plurality of brackets is located near one end of the cargo storage area and adapted to releasably support the housing members when in the expanded state. A second plurality of brackets is located near an opposite end of the cargo area and adapted to releasably support a roll-out cover extended from each of the roll-out cover mechanisms. The roll-out covers combine to substantially completely cover the cargo storage area when the housing members are supported by the first plurality of brackets and when a distal edge periphery of the roll-out covers is supported by the second plurality of brackets.

### FIELD OF THE INVENTION

The present invention relates to flexible panel covers for use in covering luggage located in a cargo storage area of a vehicle; and more particularly, to such covers that are removable.

### BACKGROUND OF THE INVENTION

Typically, luggage covers have been formed from a flexible panel rolled around a winding shaft. Such luggage covers can be permanently or releasably affixed to a vehicle at one end of the cargo storage area. The flexible panel can be unrolled from the winding shaft to cover luggage in the cargo storage area. A rod at the distal peripheral end of the flexible panel typically cooperates with retaining members at the other end of the cargo storage area to releasably support this end of the flexible panel. A biasing force acting on the winding rod generally retains the flexible panels in a taut, substantially horizontal position covering the cargo storage area when in this position. The biasing force also serves to cause the flexible panel to retract onto the winding shaft.

In certain instances, it has been desirable to selectively remove the luggage cover from its normal position and store it elsewhere. For example, in some vehicles, the rear seat folds down to increase the volume of the cargo storage area. Thus, it can be desirable to remove the luggage cover to avoid it from interfering (in its retracted panel position) with the increased cargo storage area. Once removed, the luggage cover must be stored elsewhere; typically, somewhere in the vehicle. One disadvantage associated with such luggage covers, is they tend to be fairly long which makes them difficult to conveniently store elsewhere in the vehicle. In addition, if one part of a 60/40 split fold seat is folded down, it is convenient to be able to remove the cover associated with that half to provide clear access.

### SUMMARY OF THE INVENTION

In accordance with one aspect of the present invention, a collapsible cover assembly for a cargo storage area of a vehicle includes a first and second flexible sheet panel wound on first and second winding shafts, respectively. A collapsible length housing supports the first and second winding shafts in offset axial position relative to each other to permit the first and second winding shafts to move longitudinally past each other upon moving the collapsible housing between an expanded state having a first overall length and a collapsed state having a second, lesser overall length. The first and second flexible sheet panels cooperate to substantially cover the cargo storage area when the collapsible housing is in the expanded state and when the first and second flexible sheet panels are extended from their respective winding shafts.

In accordance with another aspect of the present invention, a collapsible length cover assembly for a cargo storage area of a vehicle includes a first housing member. A second housing member is associated with the first housing member and operable to move in telescoping relationship to the first housing member between an expanded state and a collapsed state. A first roll-out cover mechanism is attached to the first housing member and a second roll-out cover mechanism is attached to the second housing member. The roll-out cover mechanisms are positioned to avoid interfering with each other upon telescoping movement of the first housing member in relation to the second housing member. Tthe first roll-out cover mechanism cooperates with the second roll-out cover mechanism to provide a combined cover for the cargo storage area when the collapsible length cover assembly is in the expanded state and when a roll-out cover is extended from each of the roll-out cover mechanisms.

In accordance with yet another aspect of the present invention, a vehicle including a collapsible length cover mechanism for a cargo storage area of the vehicle is provided. The vehicle includes a first housing member and a second housing member associated with the first housing member and operable to move in telescoping relationship to the first housing member between an expanded state and a collapsed state. A first roll-out cover mechanism is attached to the first housing member. A second roll-out cover mechanism is attached to the second housing member and positioned to avoid interfering with the first roll-out cover mechanism upon telescoping movement of the first housing member in relation to the second housing member. A first plurality of brackets is located near one end of the cargo storage area and adapted to releasably support the first and second housing members when in the expanded state. A second plurality of brackets is located near an opposite end of the cargo area adapted to releasably support a roll-out cover extended from each of the roll-out cover mechanisms. The roll-out covers combine to cover the cargo storage area when the first and second housing members are supported by the first plurality of brackets and when a distal edge periphery of the roll-out covers are supported by the second plurality of brackets.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of one embodiment of a luggage cover according to the present invention in an expanded position;

FIG. 2 is a perspective view of the luggage cover of FIG. 1 in a collapsed position;

FIG. 3 is an exploded perspective view of the luggage cover of FIGS. 1 and 2;

FIG. 4 is a cross-sectional view of the luggage cover of the above figures;

FIG. 5 is a perspective view of the luggage cover of the above figures in a vehicle with the flexible sheet panel in a retracted position; and

FIG. 6 is a perspective view of the luggage cover of the above figures in a vehicle with the flexible sheet panel extended to cover a cargo storage area.

### DETAILED DESCRIPTION OF THE PREFERRED EMBODIMENTS

The following description of the preferred embodiment(s) is merely exemplary in nature and is in no way intended to limit the invention, its application, or uses. As used herein, terms such as “first” and “second” are intended simply to distinguish between two identically named features. Thus, these terms do not connote any level of importance to the features. As used herein, the term “rod” means an elongate member and does not connote any particular cross-sectional shape to such a member.

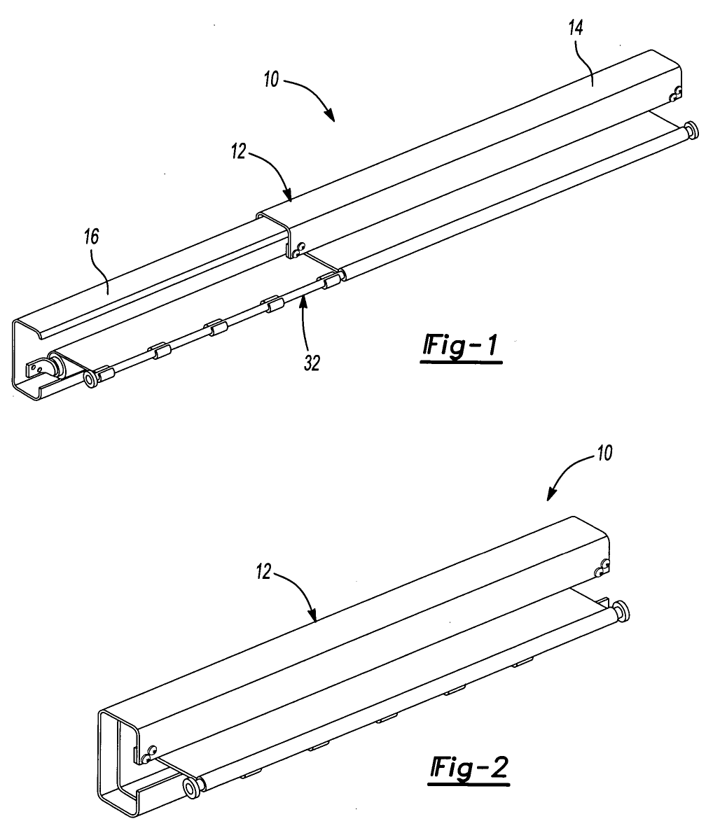

Referring to FIGS. 1 through 4, one embodiment of a luggage cover assembly 10 of the present invention includes a collapsible housing 12. In this embodiment, the collapsible housing is formed from two generally C-shaped housing members 14, 16 that telescope with respect to each other. Each of the housing members 14, 16 has a roll-out cover mechanism 18 and 20, respectively, associated therewith. Each roll-out cover mechanism 18, 20 includes a flexible sheet panel 22 and 24, respectively, wound on a winding shaft 26 and 28, respectively, and spring biased to tend to resist unwinding of the panel member 22, 24 as is known in the art.

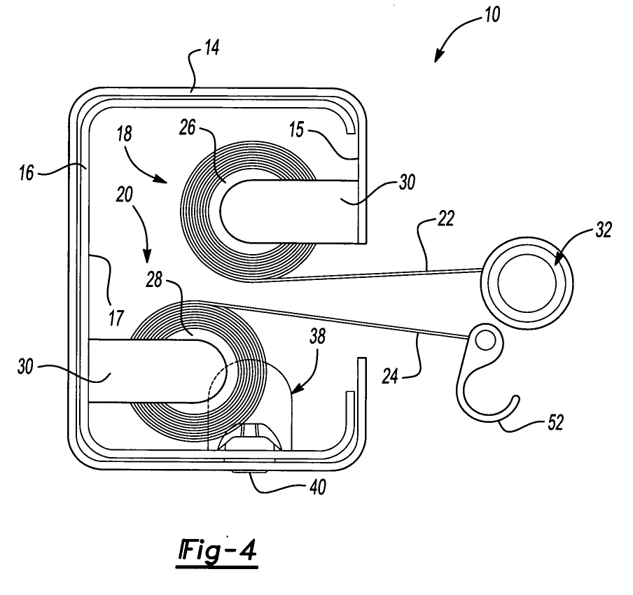

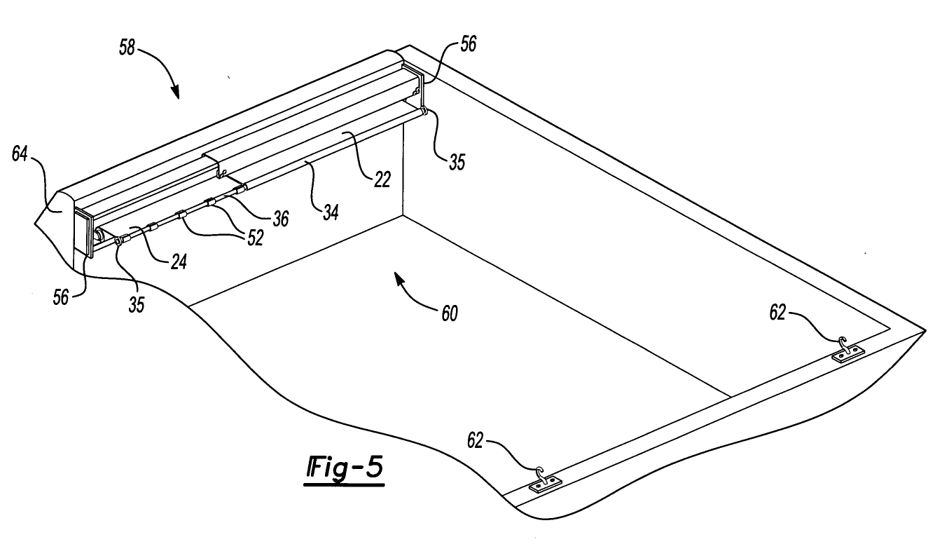

Mounting brackets 30 attach the first roll-out cover mechanism 18 to the first, larger generally C-shaped housing member 14 on a downwardly extending wall 15 (seen in FIG. 4) near the opening of the generally C-shape. A collapsible rod member 32 is attached to the distal peripheral edge of the flexible sheet panel 22 of the first roll-out cover mechanism 18. As with the housing 12, the collapsible rod member 32 is formed from two telescoping rod members 34 and 36. The smaller rod member 36 can move between an expanded (or in-use) state as seen in FIG. 1, and a collapsed (or storage) state as seen in FIG. 2. Although the rod members 34, 36 are illustrated herein as having a circular cross-section, the rod members 34, 36 could have any suitable cross-section.

In the collapsed state, the smaller rod member 36 is located substantially within the larger rod member 34. In the expanded state, the smaller rod member 36 extends outwardly from the larger rod member 34. Detents and cooperating projections (not seen) can be included to prevent the smaller rod member 36 from coming completely out of the larger rod member 34. A flange merriber 35 is located at a distal end of each of the rod members 34, 36 that operates as retaining members as discussed hereinafter.

Mounting brackets 30 also attach the second roll-out cover mechanism 20 to a central wall 17 (seen in FIG. 4) of the second, smaller generally C-shaped housing member 16. The location of the mounting brackets 30 and the roll-out cover mechanisms 18, 20 in each housing member 14 and 16, respectively, permits the telescoping action without the roll-out cover mechanisms 18, 20 interfering with each other. The winding shafts 26, 28 of the roll-out cover mechanisms 18 and 20, respectively, are located in offset axial position relative to each other permitting the roll-out cover mechanisms 18, 20 to move longitudinally past each other upon collapsing the housing 12.

Also attached to the second housing member 16 is a detent mechanism 38. This detent mechanism 38 includes a pin 40, a spring 42 and a housing 44. The pin 40 is biased by the spring 42 to selectively protrude into openings 46, 48 in the first, larger housing member 14. Thus, when the pin 40 protrudes into opening 46, the luggage cover assembly 10 is retained in the collapsed (or storage) state. Similarly, when the pin 40 protrudes into opening 48, the luggage cover assembly 10 is retained in the expanded (or in-use) state. The pin 40 can be manually depressed in order to permit telescoping action of the first and second housing members 14 and 16, respectively, relative to each other.

An auxiliary rod member 50 is releasably associated with the distal edge periphery of the flexible panel 24 of the second roll-out cover mechanism 20. Attached to this auxiliary rod member 50 is a series of releasable fasteners 52 that are configured substantially in the shape of hooks. Tubular spacers 54 are located on the auxiliary rod member 50 between the releasable fasteners 52 to maintain the fasteners 52 substantially equidistant from each other along the auxiliary rod member 50. The fasteners 52 can be frictionally engaged on the smaller rod member 36 as seen in FIGS. 1, 5 and 6. As an alternative to frictional engagement, the fasteners 52 can simply hook onto the smaller rod member 36, relying on the biasing force of the roll-up cover mechanism 20 to retain the hook fasteners 52 on the rod member 36. The fasteners 52 can also be selectively removed from the smaller rod member 36 to permit the smaller rod member 36 to telescope inside the larger rod member 34 as seen in FIGS. 2 and 4.

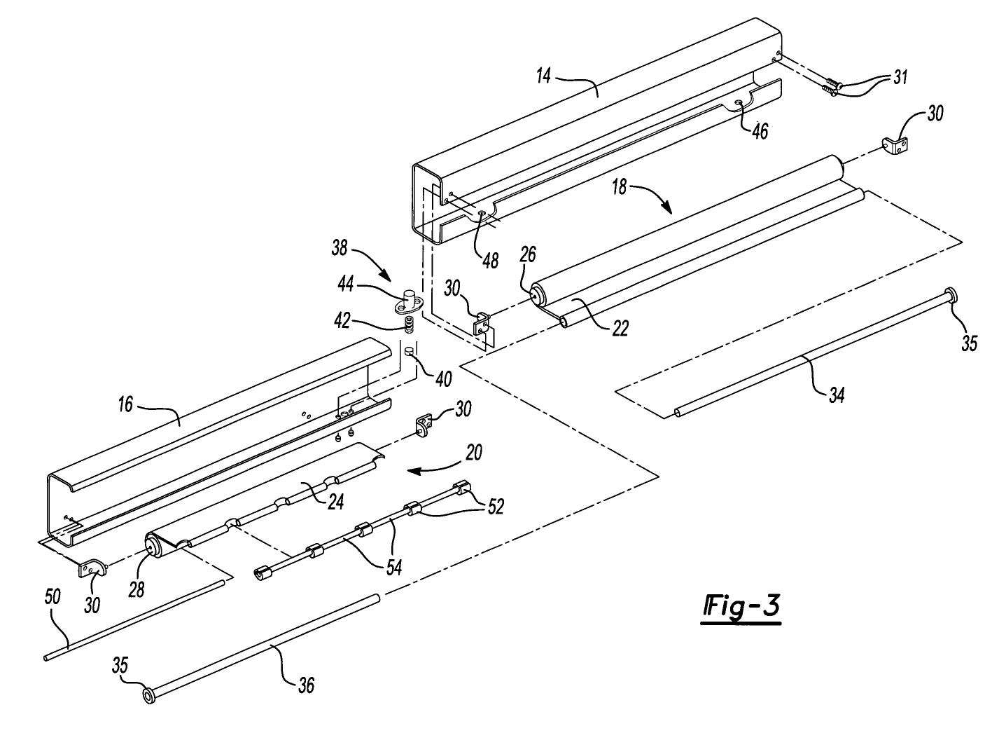

To use the collapsible luggage cover assembly 10, it is typically initially stored in a vehicle in the collapsed state as illustrated in FIG. 2. In this collapsed (or storage) state, the overall longitudinal length of the luggage cover assembly is relatively short as seen in FIG. 2. Thus, in the collapsed state, the luggage cover assembly 10 takes up a relatively small amount of space, making it relatively easier to store in the vehicle. The pin 40 of the detent mechanism 38 extends into the opening 46 of the first housing member 14 (seen best in FIG. 3). Therefore, the detent mechanism 38 operates to retain the luggage cover assembly 10 in this collapsed state during storage.

To prepare the luggage cover assembly 10 for use, a user presses the pin 40 of the detent mechanism 38, pushing the pin 40 out of opening 46 (seen in FIG. 3) to allow the generally C-shaped housing members 14, 16 to telescope outwardly relative to each other. While telescoping the collapsible housing 12 of the luggage cover assembly 10 into its expanded state, the distal end of each generally C-shaped housing members 14, 16 is inserted into a cooperating housing bracket 56 fixed to the vehicle 58 near one end of the cargo storage area 60 as seen in FIG. 5. The housing brackets 56 include recesses into which the distal ends of the collapsible housing 12 can be received and held, thereby operating as retaining members. The pin 40 of the detent mechanism 38 is moved into the opening 48 of the housing member 14 under the biasing force of the spring 42 when the collapsible luggage cover assembly 10 reaches its expanded (or in-use) state. Thus, the detent mechanism 38 serves to retain the luggage cover in its expanded state, which also retains the distal ends of the collapsible housing 12 in the housing brackets 56.

In an alternative embodiment (not seen), the distal end of each of the generally C-shaped housing members may include an end cap attached thereto. The end cap can comprise cooperating retaining members thereon and the brackets can comprise retaining members. Thus, the retaining members and the cooperating retaining members work together to selectively retain the housing of the luggage cover in position near one end of the cargo storage area. The retaining members and the cooperating retaining members can include pins and recesses, snap-in arrangements, or any other appropriate cooperating structures.

Returning to FIG. 5, after telescoping the luggage cover assembly 10 into its expanded state, the smaller rod member 36 is telescoped out of the larger rod member 34 located at the distal edge periphery of the first flexible sheet panel 24. Then, the hook fasteners 52 associated with the distal edge periphery of the second flexible sheet panel 22 are fit onto the extended smaller rod member 36. With the hooks 52 attached to the smaller rod member 36, the interior side edge peripheries of the flexible sheet panels 22 and 24 overlap slightly. In addition, the interior side edge peripheries of the flexible sheet panels 22 and 24 are positioned very close together vertically. As best seen in FIG. 4, the upper flexible sheet panel 22 rolls off of the bottom of its winding shaft 26 and the lower flexible sheet panel 24 rolls off of the top of its winding shaft 28. This arrangement, along with the proximity provided when attached to the telescoping rod 32, provides close vertical proximity of the flexible sheet panels 22 and 24 along their entire interior side edge peripheries.

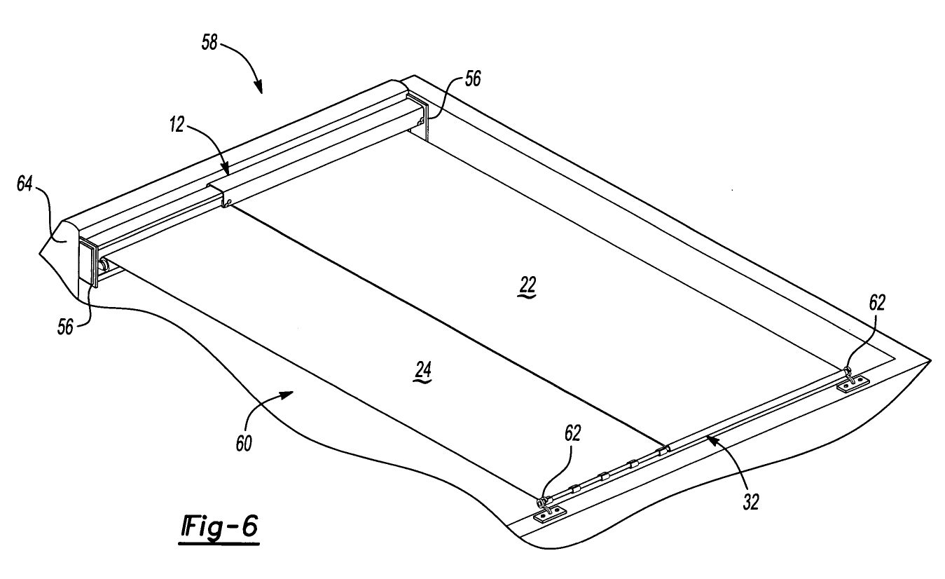

Referring to FIG. 6, a user grasps the telescoping rod 32 and extends the flexible sheet panels 22, 24 from the roll-out cover mechanisms 18 and 20, respectively. The flange 35 at each distal end of the telescoping rod 32 are then inserted into cooperating rod flange brackets 62 that operate as retaining members and are located near the opposite end of the cargo storage area 60. A biasing force acting on the winding rods 26, 28 biases the flexible sheet panels 22, 24 toward their retracted position (as seen in FIGS. 1 through 5). Thus, when the flexible sheet panels 22, 24 are in an extended position (for example, as seen in FIG. 6) the biasing force of the roll-out cover mechanisms 18 and 20, respectively, tensions the flexible cover panels 22, 24, pulling them taut in a substantially horizontal orientation.

To remove and store the luggage cover assembly 10, the above-described procedure is essentially simply reversed. This may be desirable, for example, where the vehicle 58 includes a fold-down seat 64 to enlarge the cargo storage area as seen in FIGS. 5 and 6. When the fold-down seat 64 is moved to its down position, the luggage cover assembly 10 in the brackets 56 as seen in FIG. 5 becomes located in the middle of the enlarged cargo storage area 60. Consequently, it is often desirable to remove the luggage cover assembly 10 from the brackets 56 and store it elsewhere.

To facilitate storage of the luggage cover assembly 10, its overall length is reduced by collapsing the housing 12 as is apparent from the description above. The overall longitudinal length of the luggage cover assembly 10 in its storage state is preferably less than about 75 percent of the overall longitudinal length of the luggage cover assembly 10 when in its expanded state; more preferably, less than about 60 percent; and even more preferably, less than about 55 percent. Accordingly, the luggage cover assembly 12 takes up meaningfully less space in its storage state than in its expanded state, and therefore, is easier to store.

Only a small number of the many possible alternatives are described above. Many additional modifications and alternatives beyond those described above, may be envisioned by those skilled in the art. For example, the fasteners 52 which releasably associate the distal end periphery of the second flexible sheet panel 24 to the smaller rod member 36 could have a wide variety of configurations. Such variations include snaps, clips, or any other suitable snap-fit or friction fit arrangements and combinations thereof.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A collapsible cover assembly for a cargo storage area of a vehicle comprising:
a first flexible sheet panel wound on a first winding shaft;
a second flexible sheet panel wound on a second winding shaft; and
a collapsible length housing supporting the first and second winding shafts in offset axial position relative to each other permitting the first and second winding shafts to move longitudinally past each other upon moving the collapsible housing between an expanded state having a first overall length and a collapsed state having a second overall length that is less than the first overall length;
wherein the first and second flexible sheet panels cooperate to substantially cover the cargo storage area when the collapsible housing is in the expanded state and when the first and second flexible sheet panels are extended from their respective winding shafts.

2. A collapsible cover assembly according to claim 1, further comprising a retaining member associated with a distal edge periphery of each flexible sheet panel and adapted to cooperate with a second retaining member fixed to the vehicle adjacent an opposing end of the cargo area to releasably support the flexible sheet panels.

3. A collapsible cover assembly according to claim 2, wherein each retaining member is associated with a distal end of an elongate collapsible member.

4. A collapsible cover assembly according to claim 5, wherein at least one of the flexible sheet panels is releasably associated with the elongate collapsible member.

5. A collapsible cover assembly according to claim 1, wherein an overall length of the collapsible cover assembly in the collapsed state is less than about 60 percent of an overall length of the collapsible cover assembly in the expanded state.

6. A collapsible cover assembly according to claim 1, further comprising a detent mechanism associated with the housing and adapted to retain the collapsible cover assembly in at least one of the expanded state and the collapsed state.

7. A collapsible cover assembly according to claim 1, wherein the collapsible length housing comprises a first housing member telescopingly arranged with respect to a second housing member.

8. A collapsible length cover assembly for a cargo storage area of a vehicle comprising:
a first housing member;
a second housing member associated with the first housing member and operable to move in telescoping relationship to the first housing member between an expanded state and a collapsed state;
a first roll-out cover mechanism attached to the first housing member;
a second roll-out cover mechanism attached to the second housing member and positioned to avoid interfering with the first roll-out cover mechanism upon telescoping movement of the first housing member in relation to the second housing member;
wherein the first roll-out cover mechanism cooperates with the second roll-out cover mechanism to provide a combined cover for the cargo storage area when the collapsible length cover assembly is in the expanded state and when a roll-out cover is extended from each of the roll-out cover mechanisms.

9. A collapsible length cover mechanism according to claim 8, wherein each of the first and second roll-out cover mechanisms further comprises a flexible sheet panel and an elongate rod associated with a distal edge periphery of the flexible sheet panel.

10. A collapsible length cover mechanism according to claim 9, wherein the elongate rod associated with one of the first and second roll-out cover mechanisms is telescopingly arranged with respect to the elongate rod associated with the other of the first and second roll-out cover mechanisms.

11. A collapsible length cover mechanism according to claim 10, wherein the other of the first and second cover mechanisms is releasably associated with the elongate rod by hooks.

12. A collapsible length cover mechanism according to claim 8, wherein the first housing member has a generally C-shaped cross-sectional shape and the second housing member has a smaller generally C-shaped cross sectional shape telescoping inside the first housing member.

13. A collapsible length cover mechanism according to claim 8, further comprising a detent mechanism to retain the first and second housing members in at least one of the expanded state and the collapsed state, and wherein the detent mechanism includes a biased pin member.

14. A collapsible length cover mechanism according to claim 8, wherein the combined cover for the cargo storage area is substantially continuous when the collapsible length cover assembly is in the expanded state and when the roll-out cover is extended from each of the roll-out cover mechanisms.

15. A vehicle including a collapsible length cover mechanism for a cargo storage area of the vehicle comprising:
a first housing member;
a second housing member associated with the first housing member and operable to move in telescoping relationship to the first housing member between an expanded state and a collapsed state;
a first roll-out cover mechanism attached to the first housing member;
a second roll-out cover mechanism attached to the second housing member and positioned to avoid interfering with the first roll-out cover mechanism upon telescoping movement of the first housing member in relation to the second housing member;
a first plurality of brackets located near one end of the cargo storage area and adapted to releasably support the first and second housing members when in the expanded state;
a second plurality of brackets located near an opposite end of the cargo area adapted to releasably support a roll-out cover extended from each of the roll-out cover mechanisms;
wherein the roll-out covers combine to cover the cargo storage area when the first and second housing members are supported by the first plurality of brackets and when a distal edge periphery of the roll-out covers are supported by the second plurality of brackets.

16. A vehicle including a collapsible length cover mechanism according to claim 15, further comprising an elongate rod associated with a distal edge periphery of each roll-out cover and each elongate rod being adapted to cooperate with the second plurality of brackets.

17. A vehicle including a collapsible length cover mechanism according to claim 16, wherein the elongate rod associated with the distal edge periphery of the first roll-out cover is telescopingly arranged with respect to the elongate rod associated with the distal edge periphery of the second roll-out cover.

18. A vehicle including a collapsible length cover mechanism according to claim 17, further comprising fasteners associated with a distal edge periphery of one of the first and second roll-out covers to releasably associate the one of the first and second roll-out covers with the elongate rod.

19. A vehicle including a collapsible length cover mechanism according to claim 15, wherein an overall length of the first and second housing members in the collapsed state is less than about 60 percent of an overall length of the first and second housing members in the expanded state.

20. A vehicle including a collapsible length cover mechanism according to claim 15, wherein the first housing member has a generally C-shaped cross-sectional shape and the second housing member has a generally C-shaped cross sectional shape telescopingly arranged with respect to the first housing member.

21. A vehicle including a collapsible length cover mechanism according to claim 15, further comprising a detent mechanism associated with one of the first and second housing members and adapted to retain the collapsible cover assembly in at least one of the expanded state and the collapsed state.
